(19) United States
(12) Patent Application Publication
(10) Pub. No.: US 2004/0204290 A1
(43) Pub. Date: Oct. 14, 2004

(54) Vehicle including lock-up clutch

(75) Inventor: Takuya Ito, Toyota-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 10/820,713

(22) Filed: Apr. 9, 2004

(30) Foreign Application Priority Data
Apr. 10, 2003 (JP) 2003-107045

(51) Int. Cl. F16D 33/00; B60K 41/02

(52) U.S. Cl. 477/175; 192/3.29

(57) ABSTRACT

An aspect of the invention relates to a vehicle which includes a hydraulic power transmission device, including a front cover of the hydraulic power transmission device; a first oil chamber and a second oil chamber; and a lock-up clutch which is configured to directly connect an input inside and an output side of the hydraulic power transmission device when the lock-up clutch and the front cover are placed in contact with each other according to a hydraulic pressure difference between the first oil chamber and the second oil chamber, and which is in contact with the front cover even when the hydraulic pressure difference is substantially zero.

### INCORPORATION BY REFERENCE

The disclosure of Japanese Patent Engagement No. 2003-107045 filed on Apr. 10, 2003 including the specification, drawings and abstract is incorporated herein by reference in its entirety.

### BACKGROUND OF THE INVENTION

1. Field of the Invention

The invention relates to a vehicle including a lock-up clutch which can directly connect an input side and an output side of a hydraulic power transmission device when a front cover of the hydraulic power transmission and the lock-up clutch are placed in contact with each other due to a hydraulic pressure difference. More particularly, the invention relates to a technology which controls engagement force of the lock-up clutch in the case where the front cover and the lock-up clutch of the hydraulic power transmission device are disposed so as to be in contact with each other when the hydraulic pressure difference is not generated.

2. Description of the Related Art

A vehicle is known, which includes a lock-up clutch that can directly connect an input side and an output side of a hydraulic power transmission device such as a torque converter and a fluid coupling so as to directly transmit torque. The lock-up clutch is disposed between a front cover and a turbine or a pump in the hydraulic power transmission device. Therefore, the lock-up clutch divides a space between the front cover and the turbine or the pump into a disengagement side oil chamber on a front cover side and an engagement side oil chamber on a turbine or pump side. Thus, it is possible to change a contact state between the lock-up clutch and the front cover. That is to say, a contact state of the lock-up clutch is changed to engagement, disengagement or slip states using a hydraulic pressure difference between the engagement side oil chamber and the disengagement side oil chamber. The hydraulic pressure difference is obtained by subtracting the hydraulic pressure in the disengagement side oil chamber from the hydraulic pressure in the engagement side oil chamber (i.e., the hydraulic pressure in the engagement side oil chamber—the hydraulic pressure in the disengagement side oil chamber). For example, when hydraulic oil in the disengagement side oil chamber is drained and hydraulic oil is supplied to the engagement side oil chamber, the hydraulic pressure in the engagement side oil chamber becomes higher than that in the disengagement side oil chamber, that is, the hydraulic pressure difference becomes positive, and the lock-up clutch is placed in contact with the front cover. In other words, the lock-up clutch is engaged with increasingly larger engagement force.

When the lock-up clutch is engaged with increasingly larger engagement force, the hydraulic oil may flow from the engagement side oil chamber to the disengagement side oil chamber through a gap between the front cover and the lock-up clutch. As a result, an increase in the hydraulic pressure in the engagement side oil chamber may be delayed, and responsiveness in the operation of the lock-up clutch may be delayed when the lock-up clutch is engaged with increasingly larger engagement force. Also, in the case where the hydraulic pressure in the engagement side oil chamber is increased to a small extent when the lock-up clutch is semi-engaged, that is, when the lock-up clutch is placed in a slip state, as compared with when the lock-up clutch is completely engaged, the lock-up clutch may not be operated. In this case, the lock-up clutch needs to be completely engaged before being placed in the slip state.

Accordingly, a technology is proposed, which improves the responsiveness in the operation of the lock-up clutch when the lock-up clutch is engaged with increasingly larger engagement force, by suppressing the hydraulic oil from flowing from the engagement side oil chamber to the disengagement side oil chamber through the gap between the front cover and the lock-up clutch. For example, as shown in Japanese Patent Laid-Open Publication No. 11-63152, a leaf spring to which frictional material is attached is disposed in a piston constituting the lock-up clutch such that the frictional material is in contact with the front cover due to the preload of the leaf spring even when a (positive) hydraulic pressure difference is not generated. Thus, the hydraulic oil is prevented from flowing from the engagement side oil chamber to the disengagement side oil chamber by placing the front cover and the lock-up clutch in contact with each other such that a gap therebetween is not generated when the lock-up clutch is engaged with increasingly larger engagement force. Accordingly, the responsiveness in the operation of the lock-up clutch is improved when the lock-up clutch is engaged with increasingly larger engagement force.

However, the engagement force of the lock-up clutch may become extremely large due to deviation of dimension of the lock-up clutch, the leaf spring, the front cover, and the like, or individual difference of rigidity of the leaf spring when a (positive) hydraulic pressure difference is not generated. In this case, it may become difficult to perform slip control for the lock-up clutch when a load is low, and thus droning vibration may be generated. Also, the engine speed may be suddenly decreased due to a sudden decrease in the rotational speed of driving wheels, and may become unstable when brake is suddenly applied. Also, it is necessary to consider an increase in the cost due to an increase in the number of components such as the leaf spring, and durability of the leaf spring and the like.

### SUMMARY OF THE INVENTION

In view of the above, it is an object of the invention to provide a control apparatus for a lock-up clutch which can directly connect an input side and an output side of a hydraulic power transmission device when a front cover of the hydraulic power transmission device and the lock-up clutch are placed in contact with each other due to a hydraulic pressure difference. More particularly, it is an object of the invention to provide a vehicle in which an engagement/disengagement state of the lock-up clutch is appropriately controlled in the case where the front cover of the hydraulic power transmission device and the lock-up clutch are disposed so as to be in contact with each other when the hydraulic pressure difference is not generated.

In order to achieve the object, an aspect of the invention relates to a vehicle which includes a front cover of the hydraulic power transmission device, a first oil chamber and a second oil chamber to and from each of which predetermined hydraulic pressure is provided, and each of which is in the hydraulic power transmission device, a lock-up clutch which is configured to directly connect an input side and an output side of the hydraulic power transmission device when the lock-up clutch and the front cover are placed in contact with each other according to a hydraulic pressure difference between the first oil chamber and the second oil chamber, and a lock-up clutch control portion which controls engagement force of the lock-up clutch with respect to the front cover by changing pressing force that presses the lock-up clutch to the front cover, the pressing force being changed by changing the hydraulic pressure difference, and wherein the lock-up clutch is in contact with the front cover due to predetermined pressing force when the hydraulic pressure difference is zero.

Thus, the lock-up clutch is configured to be in contact with the front cover of the hydraulic power transmission device due to predetermined pressing force when the hydraulic pressure difference is not generated. In addition, engagement force of the lock-up clutch is controlled by changing a contact state between the lock-up clutch and the front cover of the hydraulic power transmission device, the contact state being changed by changing the hydraulic pressure difference so as to be a negative value or a positive value. Therefore, the lock-up clutch can be placed in the slip state not only when the hydraulic pressure difference is a positive value but also when the hydraulic pressure difference is a negative value. Thus, the lock-up clutch can be appropriately controlled in a range from a complete engagement state in which the engagement force is largest, to a slip state in which the engagement force is substantially zero. For example, since the lock-up clutch can be placed in the slip state from the disengagement state even when the hydraulic pressure difference is a negative value, the lock-up clutch can be placed in the slip state by increasing the hydraulic pressure in the engagement side oil chamber to a relatively small extent. Also, the slip control for the lock-up clutch can be appropriately performed even when the load is low. Therefore, it is possible to prevent occurrence of the droning vibration of the vehicle, or to prevent a sudden decrease in the engine speed when brake is suddenly engaged. Thus, the stable engine speed can be maintained. Also, the cost can be reduced as compared with a torque converter having a similar configuration using a component such as a leaf spring or the like. Further, durability of the leaf spring or the like does not need to be considered.

Also, the vehicle according to the aforementioned aspect may further include a shifting control portion which controls shifting by switching between an engagement state and a disengagement state of a frictional engagement device in an automatic transmission to which output torque of an engine is input, the shifting control portion placing the automatic transmission in a neutral state by causing the frictional engagement device to be semi-engaged or to be disengaged when a rotational speed of the engine is equal to or lower than a predetermined rotational speed while the vehicle is stopped. Thus, by placing the automatic transmission in the neutral state, that is, by closing a power transmission path, a load applied to the engine can be prevented from increasing due to an increase in the engagement force of the lock-up clutch in spite of a decrease in a hydraulic pressure supplied from an oil pump that functions in synchronization with the engine speed to the hydraulic power transmission device when the engine speed is low, for example, when the vehicle is stopped. Accordingly, the stable engine speed is maintained. Also, since the load applied to the engine decreases, an idle speed of the engine can be decreased, and fuel consumption can be improved.

### BRIEF DESCRIPTION OF THE DRAWINGS

FIG. 1 is a schematic diagram showing a power transmission device to which the invention is applied;

FIG. 2 is a table describing engagement/disengagement of clutches and brakes for achieving gear speeds of an automatic transmission shown in FIG. 1;

FIG. 3 is a diagram describing signals input to and output from an electronic control unit provided in a vehicle according to an embodiment of the invention shown in FIG. 1;

FIG. 4 is a diagram showing an example of a shift diagram (shift map) used for shifting of the automatic transmission, which is performed by the electronic control unit shown in FIG. 3;

FIG. 5 is a lock-up region diagram which is used for controlling a lock-up clutch in the power transmission device shown in FIG. 1;

FIG. 6 is a diagram describing an example of a lock-up control device as a hydraulic pressure circuit portion concerning control of the lock-up clutch in a hydraulic pressure control circuit shown in FIG. 3;

FIG. 7 is a diagram showing, in detail, a torque converter including a lock-up clutch according to an embodiment of the invention;

FIG. 8 is a diagram showing, in detail, a torque converter including a lock-up clutch according to a conventional example;

FIG. 9 is a function block diagram describing a main portion of a control function of the electronic control unit in FIG. 3, which performs control of the hydraulic pressure control circuit;

FIG. 10 is a graph showing an example of a relation between a hydraulic pressure difference and pressing force applied to the front cover by the lock-up clutch;

FIG. 11 is a time chart showing a case where the lock-up clutch is controlled so as to be placed in the slip state from the disengagement state according to the embodiment of the invention shown in FIG. 7;

FIG. 12 is a time chart showing a case where the lock-up clutch is controlled so as to be placed in the slip state from the disengagement state according to the conventional example shown in FIG. 8; and

FIG. 13 is a time chart showing a case where the lock-up clutch is controlled so as to be placed in the slip state from the disengagement state according to the conventional example shown in FIG. 8, particularly a case where movement of a clutch piston toward the front cover is delayed.

### DETAILED DESCRIPTION OF THE PREFERRED EMBODIMENTS

Hereinafter, an embodiment of the invention will be described in detail with reference to an embodiment of the invention.

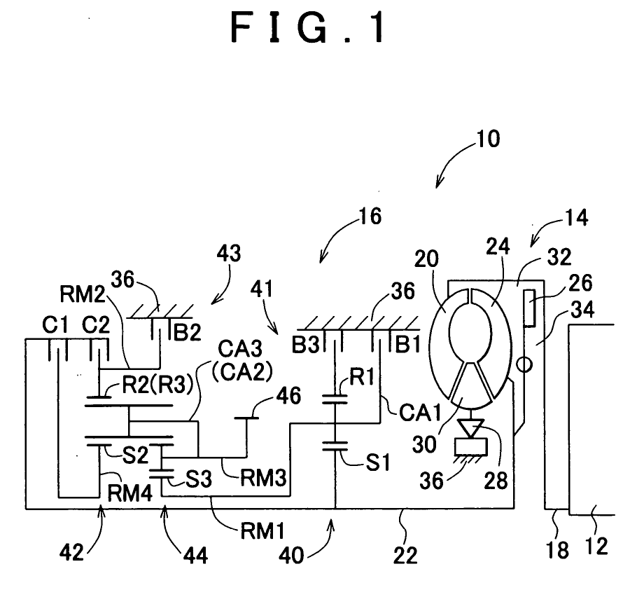

FIG. 1 is a schematic diagram describing a configuration of a power transmission device for a vehicle 10 to which the invention is applied. The power transmission device for a vehicle 10 includes a transversely-mounted automatic transmission 16, and is appropriately used in a front-engine front-drive vehicle. The vehicle includes an engine 12 as a power source for running. For example, output of the engine 12 that is configured as an internal combustion engine is transmitted to right and left driving wheels via a torque converter 14 which is a hydraulic power transmission device, the automatic transmission 16, a differential gear device (not shown), a pair of axles, and the like.

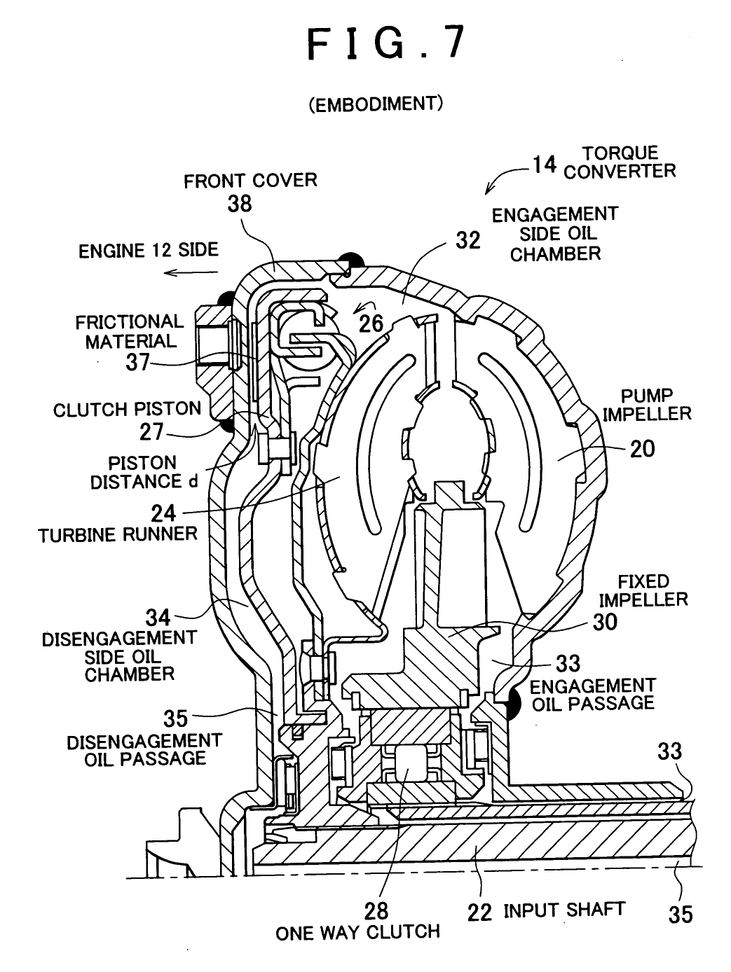

The aforementioned torque converter 14 includes a pump impeller 20 which is coupled to a crank shaft 18 of the engine 12; a turbine runner 24 coupled to an input shaft 22 of the automatic transmission 16; and a fixed impeller 30 which is coupled to a transmission case 36 via a one-way clutch 28. The torque converter 14 transmits power using fluid. A lock-up clutch 26 is provided between the pump impeller 20 and the turbine runner 24 (refer also to FIG. 7). The lock-up clutch 26 is a hydraulic friction clutch which is frictionally engaged due to a hydraulic pressure difference ΔP that is a difference between an hydraulic pressure in an engagement side oil chamber 32 and a hydraulic pressure in a disengagement side oil chamber 34. When the lock-up clutch 26 is completely engaged, the pump impeller 20 and the turbine runner 24 are integrally rotated. Also, the hydraulic pressure difference ΔP, that is, engagement torque is controlled through feedback such that the lock-up clutch 26 is placed in a predetermined slip state. Therefore, when the vehicle is driven, the turbine runner 24 is rotated in accordance with the rotation of the pump impeller 20 such that a slip amount becomes equal to a predetermined slip amount of approximately 50 rpm, for example. When the vehicle is not driven, for example, in case that a reverse input is transmitted from the driving wheel side to the engine 12 side when the vehicle is coasting (decelerating) forward with the throttle opening amount θ_{TH} being substantially zero, the pump impeller 20 is rotated in accordance with the rotation of the turbine runner 24 such that the slip amount becomes equal to a predetermined slip amount of approximately−50 rpm, for example.

The aforementioned automatic transmission 16 includes a first shifting portion 41 and a second shifting portion 43 on the same axis. The first shifting portion 41 includes a first planetary gearset 40 of single pinion type as a main portion thereof. The second shifting portion 42 includes a second planetary gearset 42 of single pinion type, and a third planetary gearset 44 of double pinion type as a main portion thereof. The automatic transmission 16 changes the rotational speed of the input shaft 22, and produces an output from an output gear 46. The input shaft 22 is equivalent to an input member. The input shaft 22 is, for example, a turbine shaft of a torque converter which is driven by a driving source for running, such as an engine. The output gear 46 is equivalent to an output member. The output gear 46 is engaged with a differential gearset via a counter shaft or directly, and drives the right and left driving wheels. The automatic transmission for a vehicle 16 is configured so as to be substantially symmetrical with respect to a center line, and a portion below the center line is omitted in FIG. 1. An embodiment of the invention will be described based on the aforementioned configuration.

The first planetary gearset 40 constituting the first shifting portion 41 includes three rotational elements, that is, a sun gear S1, a carrier CA1, and a ring gear R1. When the sun gear S1 is coupled to the input shaft 22 so as to be rotated, and the ring gear R1 is fixed to the transmission case (housing) 36 so as to be non-rotatable via a third brake B3, the rotational speed of the carrier CA1, which is an intermediate output member, is decreased with respect to the rotational speed of the input shaft 22, and the carrier CA1 produces an output. Also, the second planetary gearset 42 and the third planetary gearset 44, which constitute the second shifting portion 43, are partly coupled to each other so as to constitute four rotational elements RM1 to RM4. More particularly, the sun gear S3 of the third planetary gearset 44 constitutes the first rotational element RM1. The ring gear R2 of the second planetary gearset 42 and the ring gear R3 of the third planetary gearset 44 are coupled to each other so as to constitute the second rotational element RM2. The carrier CA2 of the second planetary gearset 42 and the carrier CA3 of the third planetary gearset 44 are coupled to each other so as to constitute the third rotational element RM3. The sun gear S2 of the second planetary gearset 42 constitutes the fourth rotational element RM4. In the second planetary gearset 42 and the third planetary gearset 44, the carrier CA2 and the carrier CA3 are constituted by the same member, and the ring gear R2 and the ring gear R3 are constituted by the same member. Also, a pinion gear of the second planetary gearset 42 serves also as a second pinion gear of the third planetary gearset 44. Thus, the second planetary gearset 42 and the third planetary gearset 43 form a gear train of Ravingneaux type.

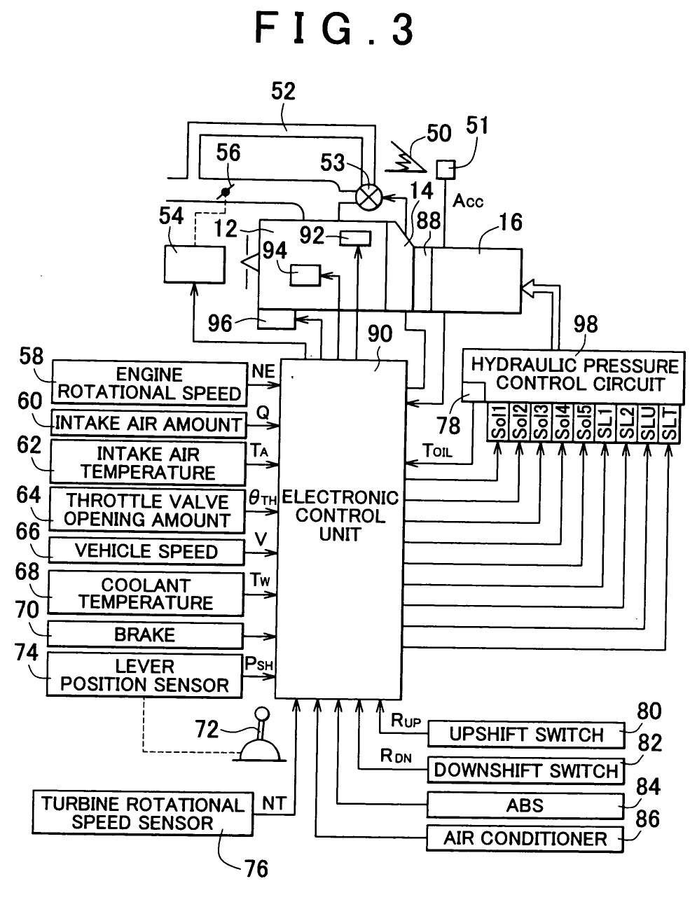

When the output is produced, the first to fourth rotational elements RM1 to RM4 are operated as follows. The first rotational element RM1 (sun gear S3) is selectively coupled to the case 36 by a first brake B1 such that the rotation of the first rotational element RM1 is stopped. The second rotational element RM2 (ring gears R2, R3) is selectively coupled to the case 36 such that the rotation of the second rotational element RM2 is stopped. The fourth rotational element RM4 (sun gear S2) is selectively coupled to the input shaft 22 via the first clutch C1. The second rotational element RM2 (ring gears R2, R3) is selectively coupled to the input shaft 22 via the second clutch C2. The first rotational element RM1 (sun gear S3) is integrally coupled to a carrier CA1 of the first planetary gearset 40 which is the intermediate output member. The third rotational element RM3 (carriers CA2, CA3) are integrally coupled to the output gear 46. Thus, the output 46 produces the output. Each of the first brake B1 to the third brake B3, the first clutch C1, and the second clutch C2 (hereinafter, referred to as clutch C and brake B when each of the clutches and the brakes does not need to be distinguished from others) is a hydraulic frictional engagement device whose engagement is controlled by a hydraulic actuator, such as a multiple disc clutch and a multiple disc brake. The state of the hydraulic pressure circuit is changed due to excitation/non-excitation of solenoid valves Sol 1 to Sol 5 and linear solenoid valves SL1, SL2, and a manual valve (not shown) in the hydraulic pressure control circuit 98 (refer to FIG. 3).

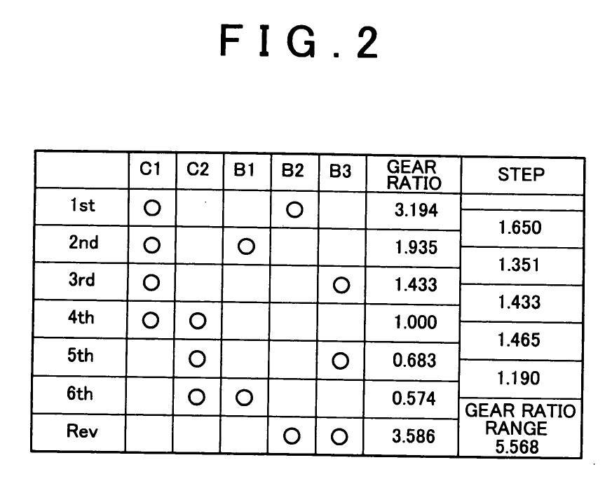

A table in FIG. 2 shows a relation between shift speeds and the operation states of the clutches C1, C2, and the brakes B1 to B3. A circle indicates engagement. The gear ratio of each shift speed is appropriately decided according to a gear ratio ρ1, ρ2, ρ3 of the first planetary gearset 40, the second planetary gearset 42, and the third planetary gearset 44. For example, if ρ1 is approximately 0.60, ρ2 is approximately 0.46, and ρ3 is approximately 0.43, the gear ratios shown in FIG. 2 can be obtained. That is, each gear ratio step (ratio between gear ratios of the shift speeds which are adjacent to each other) becomes an approximately appropriate value, a gear ratio range (3.194 to 0.574) becomes approximately 5.6 which is a large value, and the gear ratio of a reverse shift speed “Rev” becomes an appropriate value. Accordingly, it is possible to obtain appropriate gear ratio characteristics on the whole. As described above, in the automatic transmission for a vehicle 16 according to the embodiment of the invention, multiple shift speeds, that is, six forward speeds can be achieved using the three planetary gearsets 40, 42, 44, the two clutches C1, C2, and the three brakes B1 to B3. Therefore, since the number of clutches is reduced, the weight, cost, and axial length are reduced as compared with a transmission including three clutches and two brakes. Particularly, since the gear train of Ravingneaux type is formed by the second planetary gearset of single pinion and the third planetary gearset 44 of double pinion type, which constitute the second shifting portion 43, the number of components and axial length are further reduced.

The hydraulic pressure control circuit 98 in FIG. 3 includes a linear solenoid valve SLU which mainly controls the hydraulic pressure difference ΔP between a lock-up hydraulic pressure, that is, the hydraulic pressure in the engagement side oil chamber 32 and the hydraulic pressure in the disengagement side oil chamber 34, and a linear solenoid valve SLT which mainly controls a line hydraulic pressure, in addition to the aforementioned solenoid valves for shifting Sol 1 to Sol 5, and the linear solenoid valves SL1, SL2. The hydraulic oil in the hydraulic pressure control circuit 98 is supplied to the lock-up clutch 26, and is used for lubricating various portions of the automatic transmission 16 and the like. Each of the hydraulic frictional engagement devices of the automatic transmission 16 and the lock-up clutch 26 are controlled by the hydraulic pressure control circuit 98 using, as original pressure, the hydraulic pressure generated by the oil pump 88 which is mechanically connected to the engine 12, and is directly rotated by the engine 12 in synchronization of the engine speed.

FIG. 3 is a block diagram describing a control system which is provided in the vehicle for controlling the engine 12 and the automatic transmission 16 shown in FIG. 1. An accelerator opening amount Acc, which is an operation amount of an accelerator pedal 50, is detected by an accelerator opening amount sensor 51. The accelerator pedal 50 is greatly depressed according to an output amount required by a driver. The accelerator pedal is equivalent to an accelerator operation member, and the accelerator opening amount Acc is equivalent to the required output amount. An electronic throttle valve 56 is provided in an intake pipe of the engine 12. A throttle opening amount θ_{TH} of the electronic throttle valve 56 is controlled according to the accelerator opening amount Acc using a throttle actuator 54. Also, an idle speed control valve (hereinafter, referred to as ISC valve) 53 is provided in a bypass passage 52 which bypasses the electronic throttle valve 56 for idle speed control. The ISC valve 53 controls the intake air amount when the electronic throttle valve 56 is fully closed in order to control an idle speed N_{EIDL} of the engine 12. In addition, there are provided an engine speed sensor 58, an intake air amount sensor 60, an intake air temperature sensor 62, a throttle sensor with an idle switch 64, a vehicle speed sensor 66, a coolant temperature sensor 68, a brake switch 70, a lever position sensor 74, a turbine speed sensor 76, an AT oil temperature sensor 78, an upshift switch 80, a downshift switch 82, and the like. The engine speed sensor 58 detects an engine speed N_{E} of the engine 12. The intake air amount sensor 60 detects an intake air amount Q of the engine 12. The intake air temperature sensor 62 detects an intake air temperature T_{A}. The throttle sensor with the idle switch 64 detects the throttle opening amount θ_{TH}. The vehicle speed sensor 66 detects a vehicle speed V (corresponding to a rotational speed N_{OUT} of the output shaft 46). The coolant temperature sensor 68 detects a coolant temperature T_{W} of the engine 12. The brake switch 70 detects whether a foot brake as a service brake is being operated. The lever position sensor 74 detects a lever position (operation position) P_{SH} of a shift lever 72. The turbine speed sensor 76 detects a turbine speed N_{T} (i.e., a rotational speed N_{IN} of the input shaft 22). The AT oil temperature sensor 78 detects an AT oil temperature T_{OIL} which is a temperature of the hydraulic oil in the hydraulic pressure control circuit 98. The sensors and the switches supplies an electronic control unit 90 with signals indicative of the engine speed N_{E}, the intake air amount Q, the intake air temperature T_{A}, the throttle opening amount θ_{TH}, the vehicle speed V, the engine coolant temperature T_{W}, a signal indicative of whether the foot brake is being applied, signals indicative of the lever position P_{SH} of the shift lever 72, the turbine speed N_{T}, the AT oil temperature T_{OIL}, a shift range up command R_{UP}, a shift range down command R_{DN}, and the like. Also, the electronic control unit 90 is connected to an anti lock braking system (ABS) 84 which controls braking force such that the wheels are not locked (i.e., the wheels do not slip) when the foot brake is operated, and is supplied with information concerning brake hydraulic pressure and the like corresponding to the braking force. In addition, an air conditioner 86 supplies the electronic control unit 90 with a signal indicative of whether the air conditioner 86 is operated.

The electronic control unit 90 includes a so-called microcomputer. The microcomputer includes a CPU, RAM, ROM, an input/output interface, and the like. The CPU performs signal processing according to a program that is stored in the ROM in advance using a temporary storing function of the RAM, thereby performing output control for the engine 12, shifting control for the automatic transmission 16, lock-up clutch control for the lock-up clutch 26, and the like. The CPU for engine control and the CPU for hydraulic control are separately configured, as necessary.

In the output control for the engine 12, opening/closing of the electronic throttle valve 56 is controlled by the throttle actuator 54, a fuel injection valve 92 is controlled for fuel injection amount control, an ignition device 94 such as an ignitor is controlled for ignition timing control, and the ISC valve 53 is controlled for idle speed control. In the control of the electronic throttle valve 56, the throttle valve opening amount θ_{TH} is increased with an increase in the accelerator opening amount Acc by driving the throttle actuator 54 based on the actual accelerator opening amount Acc according to, for example, a relation (map) that is set in advance. Also, when the engine 12 is started, the crank shaft 18 of the engine 12 is rotated using a starter (electric motor) 96.

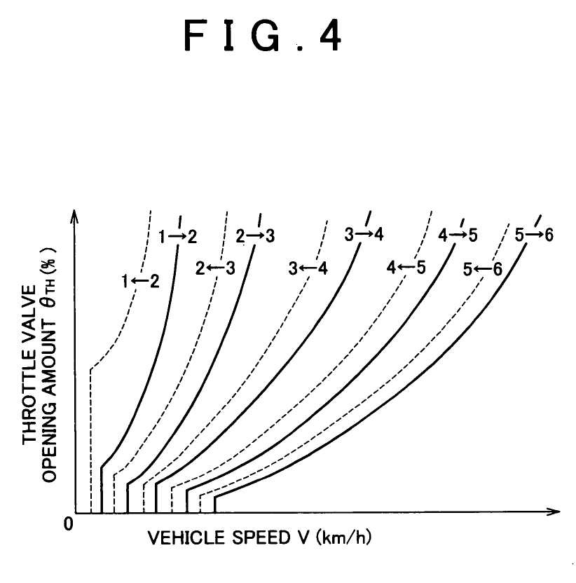

Also, in shifting control for the automatic transmission 16, a target shift speed of the automatic transmission 16 to which a present shift speed is changed is decided based on the actual throttle opening amount mθ_{TH} and the vehicle speed V using, for example, a shift diagram (shift map) in FIG. 4 that is stored in advance, according to the lever position P_{SH} of the shift lever 72 shown in FIG. 3. Then, an operation for achieving the decided target shift speed is performed. The shift lever 72 is disposed in the vicinity of the driver's seat. For example, the shift lever 72 is manually operated to four lever positions “R (reverse)”, “N (neutral)”, “D (drive)”, and “S (sequential)”. The position “R” is for reverse running, the position “N” is for interrupting power transmission, the position “D” is for forward running using automatic shifting, and the position “S” is for forward running using manual shifting. When the shift lever 72 is at the position “S”, manual shifting can be performed by switching among plural shift ranges whose shift speeds on the high speed side are different from each other. The lever position sensor 74 detects the lever position of the shift lever 72. Also, a manual valve connected to the shift lever 72 via a cable or a link is mechanically operated according to the forward/backward operation of the shift lever 72, whereby the state of the hydraulic pressure circuit is changed. When the shift lever 72 is at the position “R”, for example, a circuit for reverse running is mechanically established, whereby the reverse shift speed “Rev” shown in FIG. 2 is achieved. When the shift lever 72 is at the position “N”, a neutral circuit is mechanically established, whereby all the clutches C and brakes B are disengaged.

Also, when the shift lever 72 is operated to the position “D” or the position “S” for forward running, the state of the hydraulic pressure circuit is changed similarly by the manual valve according to the operation of the shift lever 72, whereby a circuit for forward running is mechanically established. Accordingly, it becomes possible for the vehicle to run forward while performing shifting in the forward shift speed range from a first shift speed “1st” to a sixth shift speed “6th”. When the shift lever 72 is operated to the position “D”, it is determined that the shift lever 72 is operated to the position “D” based on the signal from the lever position sensor 74, an automatic shifting mode is achieved, and shifting control is performed using all the forward shift speeds from the first shift speed “1st” to the sixth shift speed “6th”. That is, the excitation/non-excitation of each of the solenoid valves Sol 1 to Sol 5, and the linear solenoid valves SL1, SL2 is controlled so as to prevent occurrence of shift shock such as a change in the driving power, or damage to durability of the frictional material. Thus, the state of the hydraulic pressure control circuit 98 is changed so as to achieve one of the forward shift speeds from the first shift speed “1st” to the sixth shift speed “6 th”. In FIG. 4, a solid line is an upshift line, and a dashed line is a downshift line. As the vehicle speed V decreases or the throttle valve opening amount θ_{TH} increases, the present shift speed is changed to a shift speed on a low speed side in which the shift ratio (the input rotational speed N_{IN}/the output rotational speed N_{OUT}) is large. In FIG. 4, numbers “1” to “6” indicate the first shift speed “1st” to the sixth shift speed “6th”.

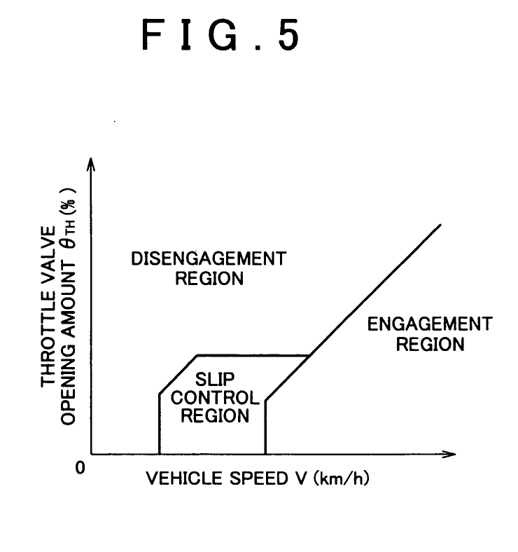

In the lock-up clutch control for the lock-up clutch 26, the engagement torque, that is, the engagement force of the lock-up clutch 26 is continuously controlled. The electronic control unit 90 functionally includes a lock-up clutch control portion 100 for controlling an engagement/disengagement and slip states of the lock up clutch 26 according to, for example, a map showing a disengagement region, a slip control region, and an engagement region that is stored in advance using the throttle valve opening amount θ_{TH} and the vehicle speed V as parameters as shown in FIG. 5. The electronic control unit 90 outputs a drive duty ratio D_{SLU}, which is a drive signal for the solenoid valve SLU. The solenoid valve SLU controls the hydraulic pressure difference ΔP for the lock-up clutch 26 for controlling a speed difference N_{SLP} (i.e., the slip amount) between the turbine speed N_{T} and the engine speed N_{E}, which is obtained by subtracting the turbine speed N_{T} from the engine speed N_{E} (i.e., N_{E}-N_{T}), to a target speed difference (a target slip amount) N_{SLP*}. In the slip control, the lock-up clutch 26 is maintained in the slip state so as to suppress loss in power transmission of the torque converter 14 as much as possible while absorbing a change in the engine speed of the engine 10 in order to improve the fuel consumption as much as possible without damaging driveability. The slip control during deceleration is performed, for example, at the shift speed at which a reverse input is transmitted from the driving wheel side to the engine 12 side when the vehicle is coasting (decelerating) forward with the throttle opening amount θ_{TH} being substantially zero. The turbine speed N_{T} and the engine speed N_{E} are gradually decreased as the vehicle is decelerating while the speed difference N_{SLP} is made to be substantially equal to the target speed difference N_{SLP*}, for example, −50 rpm through feedback control using the drive duty ratio D_{SLU} for the solenoid valve SLU. When the lock-up clutch 26 is engaged in the slip state in this manner, the engine speed N_{E} is increased so as to be close to the turbine speed N_{T}. Therefore, a fuel cut region (vehicle speed range) in which fuel supply to the engine 12 is stopped is enlarged, which improves fuel consumption.

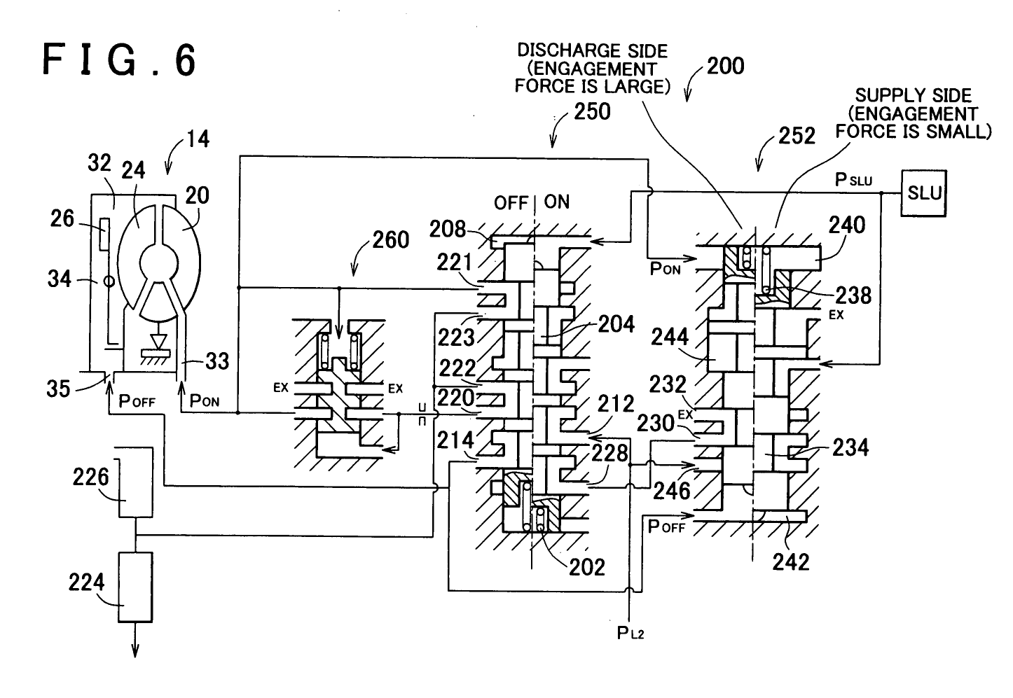

FIG. 6 is a diagram describing a lock-up control device 200 as a hydraulic pressure circuit portion concerning control of the lock-up clutch 26 in the hydraulic pressure control circuit 98 shown in FIG. 3. The linear solenoid valve SLU, which functions as a valve for generating control pressure, is a pressure reducing valve using modulator pressure P_{M} as original pressure. The linear solenoid valve SLU outputs control pressure P_{SLU} which increases according to a drive current I_{SLU} at a drive duty ratio D_{SLU} which is output from the electronic control unit 90, and supplies the control pressure P_{SLU} to a lock-up relay valve 250 and a lock-up control valve 252.

The lock-up relay valve 250 includes a spring 202 and an oil chamber 208. The spring 202 is provided at one axial end side of a spool valve element 204, and gives thrust to the spool valve element 204 such that the spool valve element 204 moves toward a disengagement (OFF) side. The oil chamber 208 is provided at the other axial end side of the spool valve element 204, and receives the control pressure P_{SLU} in order to urge the spool valve element 204 to an engagement (ON) side position. When the spool valve element 204 is at the disengagement side, second line pressure P_{L2} supplied to an input port 212 is discharged from a disengagement side port 214. Then, the second line pressure P_{L2}is supplied to the disengagement side oil chamber 34 through a disengagement oil passage 35 of the torque converter 14. At the same time, the hydraulic oil in the engagement side oil chamber 32 in the torque converter 14 passes through an engagement oil passage 33, bypasses a pressure reducing valve 260, and then passes through an engagement side bypass port 221 and a discharge port 223. Then, the hydraulic oil is discharged to a cooler bypass valve 224 or an oil cooler 226. Thus, the engagement pressure for the lock-up clutch 26, that is, the hydraulic pressure difference ΔP which is obtained by subtracting the hydraulic pressure in the disengagement side oil chamber 34 from the hydraulic pressure in the engagement side oil chamber 32 (i.e., the hydraulic pressure in the engagement side oil chamber 32—the hydraulic pressure in the disengagement side oil chamber 34) is reduced. Meanwhile, when the spool valve element 204 is at the engagement side position, the second line pressure P_{L2} supplied to the input port 212 is discharged from the engagement port 220. Then, the second line pressure P_{L2} is reduced by predetermined pressure using the pressure reducing valve 260, and the reduced second line pressure P_{L2} is supplied to the engagement side oil chamber 32 in the torque converter 14. At the same time, the hydraulic oil in the disengagement side oil chamber 34 in the torque converter 14 is discharged via a disengagement side port 214, a discharge port 228, and a control port 230 and a discharge port 232 of the lock-up control valve 252. Thus, the engagement pressure for the lock-up clutch 26 is increased.

Accordingly, when the control pressure P_{SLU} is equal to or lower than a predetermined value β, the spool valve element 204 is moved to the disengagement (OFF) side position on a left side of a center line in FIG. 6 according to thrust F₂₀₂ based on the spring 202, and thus the lock-up clutch 26 is disengaged. When the control pressure P_{SLU} is higher than a predetermined value α which is higher than the predetermined value β, the spool valve element 204 is moved to the engagement (ON) side on a right side of the center line in FIG. 6 according to the thrust F_{SLU} (F_{SLU}=P_{SLU}×S₂₀₄; S₂₀₄ is a pressure-receiving area which receives the pressure). Thus, the lock-up clutch 26 is engaged or is placed in the slip state. The pressure-receiving area S₂₀₄ of the spool valve element 204, the thrust F₂₀₂ of the spring 202 are thus set.

When the spool valve element 204 of the lock-up relay valve 250 is at the engagement side position, the lock-up control valve 252 controls the slip amount N_{SLP} according to the control pressure P_{SLU}, or causes the lock-up clutch 26 to be engaged. The lock-up control valve 252 includes a spool valve element 234, a spring 238, an oil chamber 240, an oil chamber 242, and an oil chamber 244. The spring 238 gives thrust F₂₃₈ to the spool valve element 234 such that the spool valve element 234 is moved to a supply side position on the right side of a center line in FIG. 6. The oil chamber 240 houses the spring 238, and receives hydraulic pressure P_{ON} in the engagement side oil chamber 32 in the torque converter 14 in order to urge the spool valve element 234 to the engagement side position. The oil chamber 242 receives hydraulic pressure P_{OFF} in the disengagement side oil chamber 34 in the torque converter 14 in order to urge the spool valve element 234 to the discharge side position. The oil chamber 244 receives control pressure P_{SLU}.

Therefore, when the spool valve element 234 is at the discharge side position, communication is provided between the control port 230 and the discharge port 232. Accordingly, the engagement pressure is increased, and thus the engagement torque of the lock-up clutch 26 is increased. Meanwhile, when the spool valve element 234 is at the supply side position, communication is provided between a supply port 246 to which the second line pressure P_{L2} is supplied, and the control port 230. Accordingly, the second line pressure P_{L2} is supplied to the disengagement side oil chamber 34 in the torque converter 14, and thus the engagement pressure is reduced, and the engagement torque of the lock-up clutch 26 is reduced.

When the lock-up clutch 26 is disengaged, the electronic control unit 90 drives the linear solenoid valve SLU such that the control pressure P_{SLU} becomes lower than the predetermined value β. When the lock-up clutch 26 is engaged, the electronic control unit 90 drives the linear solenoid valve SLU such that the control pressure P_{SLU} becomes maximum value. When the lock-up clutch 26 is placed in the slip state, the electronic control unit 90 drives the linear solenoid valve SLU such that the control pressure P_{SLU} becomes a value between the predetermined value β and the maximum value. That is, in the lock-up control valve 252, the hydraulic pressure P_{ON} in the engagement side oil chamber 32 and the hydraulic pressure P_{OFF} in the disengagement side oil chamber 34 are changed according to the control pressure P_{SLU} Therefore, the engagement pressure for the lock-up clutch 26, that is, the engagement torque of the lock-up clutch 26 corresponding to the hydraulic pressure difference ΔP that is a difference between the hydraulic pressure P_{ON} and the hydraulic pressure P_{OFF} (i.e., P_{ON}−P_{OFF}) is also changed according to the control pressure P_{SLU}. Thus, the slip amount N_{SLP} is controlled. For example, in the lock-up control valve 252, the hydraulic pressure difference ΔP is changed according to the control pressure P_{SLU}, as shown by an equation, (P_{ON}−P_{OFF})×S₂₃₄+F₂₃₈ =P_{SLU}×S₂₄₄ (in this equation, S₂₃₄ indicates both a pressure-receiving area of the spool valve element 234 on the oil chamber 240 side and a pressure-receiving area of the spool valve element 234 on the oil chamber 242 side. S₂₄₄ indicates a pressure-receiving area of the oil chamber 244). Thus, when the spool valve element 204 of the lock-up relay valve 250 is moved to the engagement side, the engagement state or the slip state of the lock-up clutch 26 is controlled by the lock-up control valve 252 which is operated according to the control pressure P_{SLU}.

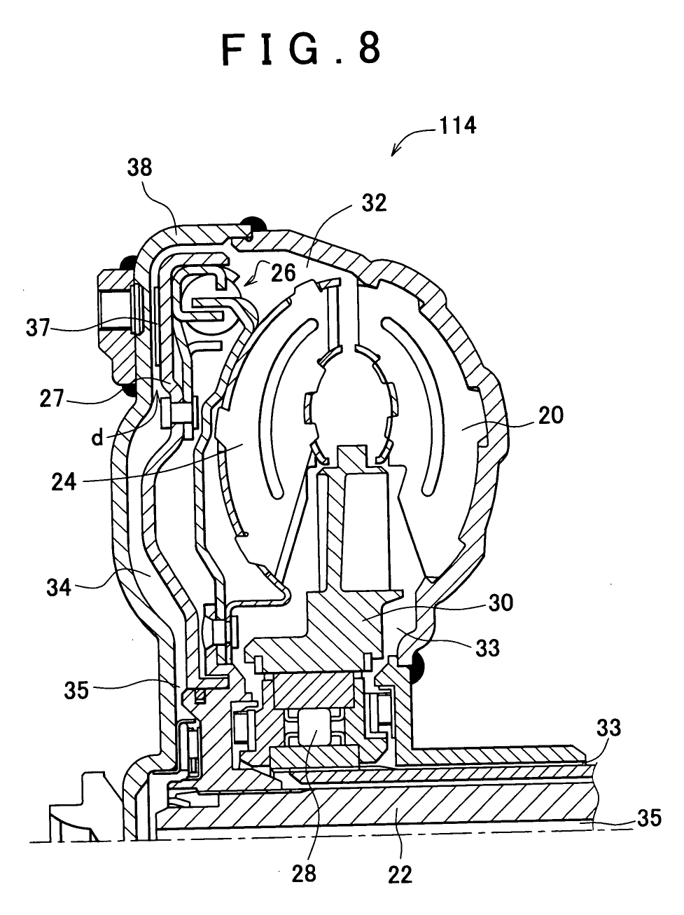

FIG. 7 is a diagram showing, in detail, the torque converter 14 including a lock-up clutch according to an embodiment of the invention. FIG. 8 is a diagram showing, in detail, a torque converter 114 including a lock-up clutch according to a conventional example. Since the configuration of the torque converter 14 or the torque converter 114 has been described above, a difference between the torque converter 14 and the torque converter 114 will be described, focusing on a piston distance d between a clutch piston 27 constituting the lock-up clutch 26 and a front cover 38 which is a cover of the torque converter 14 on the engine side. The clutch piston 27 is disposed so as to divide a space between the front cover 38 and the turbine runner 24 into the engagement side oil chamber 32 and the disengagement side oil chamber 34. As described above, a contact state between the clutch piston 27 and the front cover 38 through frictional material 37 is changed by the hydraulic pressure difference ΔP. The contact state of the lock-up clutch 26 is changed to the engagement/disengagement or slip state. In the torque converter 114 according to the conventional example, when the hydraulic pressure difference ΔP is not generated, that is, when the hydraulic pressure difference ΔP is substantially zero, the piston distance d is not zero (there is a gap between the clutch piston 27 and the front cover 38), that is, the lock up clutch 26 is disengaged, as shown in FIG. 8. Meanwhile, in the torque converter 14 according to the embodiment of the invention, when the hydraulic pressure difference ΔP is not generated, the piston distance d is substantially zero (there is no gap between the clutch piston 27 and the front cover 38), that is, the lock-up clutch 26 is in contact with the front cover 38 due to predetermined pressing force Fₚ, and thus the lock-up clutch 26 is at least in the slip state, as shown in FIG. 7. Since the torque converter according to the embodiment of the invention does not require a component such as a leaf spring, the cost is reduced as compared to a torque converter having the same configuration as the aforementioned configuration except that the leaf spring or the like is disposed in the clutch piston as disclosed by Japanese Patent Laid-Open Publication No. 11-63152. Further, since durability of the leaf spring or the like does not need to be considered, the number of man-hours required for product design can be reduced.

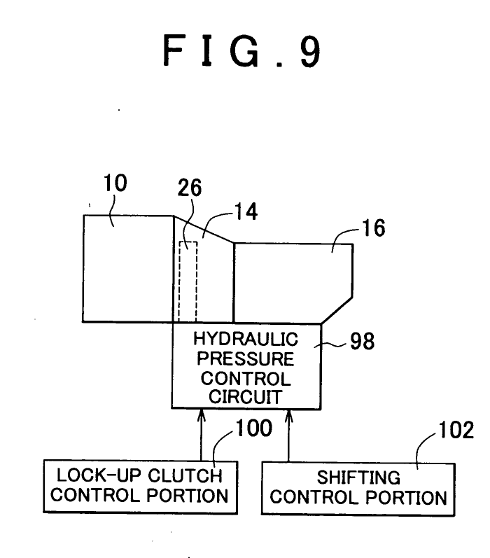

FIG. 9 is a function block diagram describing a main portion of a control function of the electronic control unit 90, which performs control of the hydraulic pressure control circuit. In FIG. 9, the lock-up clutch control portion 100 outputs a drive duty ratio D_{SLU}, which is a drive signal for the solenoid valve SLU for controlling the hydraulic pressure difference ΔP for the lock-up clutch 26, to the hydraulic pressure control circuit 98 in order to control the engagement/disengagement and slip states of the lock-up clutch 26, according to, for example, a map (relation) that is stored in advance as shown in FIG. 5. In the map, a disengagement region, a slip control region, and an engagement region are set in a two dimensional coordinate system, using the throttle valve opening amount θ_{TH} and the vehicle speed V as parameters.

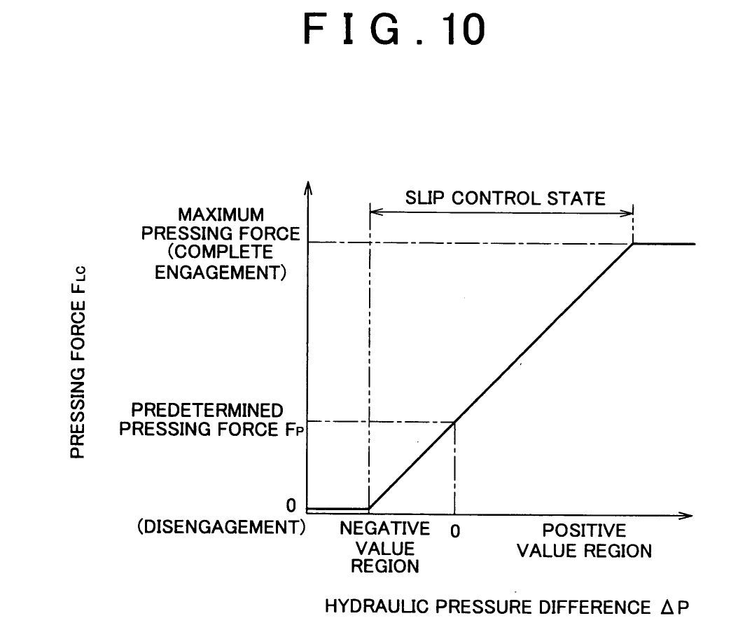

Description will be made of the slip control for the lock-up clutch 26 according to the embodiment of the invention shown in FIG. 7, which is performed by the lock-up clutch control portion 100, comparing a slip control for the lock-up clutch 26 according to the conventional example shown in FIG. 8. For example, in the conventional example, the lock-up clutch control portion 100 controls the lock-up clutch 26 such that the lock-up clutch 26 is placed in the slip state when the hydraulic pressure difference ΔP is a positive value and is equal to or higher than the predetermined hydraulic pressure difference ΔPₚ in the control of the hydraulic pressure difference ΔP using the lock-up control valve 252 that is operated according to the control pressure P_{SLU} when the spool valve element 204 of the lock-up relay valve 250 is moved to the engagement side. However, in the embodiment of the invention, the lock-up clutch 26 is controlled so as to be placed in the slip state even when the hydraulic pressure difference ΔP is substantially zero. More specifically, the lock-up clutch 26 is controlled so as to be placed in the slip state not only when the hydraulic pressure difference ΔP is a positive value but also when the hydraulic pressure difference ΔP is substantially zero or a negative value. Therefore, the engagement force of the lock-up clutch 26 can be appropriately controlled in a wide range from the complete engagement state to the slip state in which the engagement force is substantially zero. FIG. 10 is a graph showing an example of a relation between the hydraulic pressure difference ΔP and pressing force FLC applied to the front cover 38 by the lock-up clutch 26 in the embodiment of the invention. FIG. 10 indicates that the lock-up clutch 26 is in contact with the front cover 38 due to the pressing force Fₚ when the hydraulic pressure difference ΔP is zero. The pressing force Fₚ may be set to an appropriate value in a range from the pressing force F_{LC} of substantially zero to the maximum pressing force F_{LC}, based on required characteristics of the vehicle and the like. The pressing force F_{LC} is substantially zero when the lock-up clutch 26 is disengaged, and the pressing force F_{LC} is maximum when the lock-up clutch 26 is completely engaged. Also, the relation in FIG. 10 does not need to be represented by a straight line, and may be appropriately set based on the required characteristics of the vehicle and the like.

In the conventional example, in the case where the lock-up clutch control portion 100 performs control such that the lock-up clutch 26 is placed in the slip state from the disengagement state, when the hydraulic pressure P_{ON} in the engagement side oil chamber 32 is slightly increased, for example, when the hydraulic pressure difference ΔP is slightly larger than the predetermined hydraulic pressure difference ΔPₚ for the slip control, the hydraulic oil may flow into the disengagement side oil chamber 34 from the engagement side oil chamber 32 through the gap between the between the clutch piston 27 and the front cover 38, which may delay or inhibit movement of the clutch piston 27 toward the front cover 38 side. However, in the embodiment of the invention, since the piston distance is substantially zero, that is, there is no gap between the clutch piston 27 and the front cover 38 even when the hydraulic pressure difference ΔP is zero, and the lock-up clutch 26 starts to be controlled so as to be placed in the slip state when the hydraulic pressure difference ΔP is a negative value, the hydraulic oil is prevented from flowing into the disengagement side oil chamber 34 from the engagement side oil chamber 32, and thus the appropriate slip control can be started when the lock-up clutch 26 is placed in the slip state with the pressing force F_{LC} being substantially zero. Also, in the configuration in which the front cover is in contact with the lock-up clutch when the hydraulic pressure difference ΔP is substantially zero such as a configuration in which the leaf spring or the like is provided as disclosed in the Japanese Patent Laid-Open Publication No. 11-63152, the engagement force of the lock-up clutch 26, that is, the predetermined pressing force Fₚ applied to the front cover 38 may become extremely large due to individual difference caused by deviation of components and the like. Accordingly, the droning vibration and the like may occur in the case where the slip control is performed while the vehicle is decelerating when the engine output is low, for example, when fuel cut is performed for improving fuel consumption. Also, the engine speed N_{E} may be suddenly decreased due to a sudden decrease in the rotational speed of driving wheels, and may become unstable when brake is suddenly applied. However, in the embodiment of the invention, since the appropriate slip control can be performed by controlling the hydraulic pressure difference ΔP so as to be zero or a negative value. Therefore, occurrence of the droning vibration of the vehicle can be prevented, fuel cut can be performed even when the vehicle speed is lower, and the fuel consumption is improved. Also, the engine speed N_{E} is prevented from suddenly decreasing, and thus the stable engine speed N_{E} can be maintained.

The pressure reducing valve 260 included in the lock-up control device 200 reduces, for example, by predetermined pressure, the second line pressure P_{L2} which becomes the hydraulic pressure P_{ON} in the engagement side oil chamber 32 when the spool valve element 204 of the lock-up relay valve is moved to the engagement side. Thus, the second line pressure P_{L2} which becomes the hydraulic pressure P_{ON} in the engagement side oil chamber 32 is reduced so as to be lower than the second line pressure P_{L2} which is supplied via the supply port 246 and the control port 230 of the lock-up control valve 252, and which becomes the maximum hydraulic pressure P_{OFF} in the disengagement side oil chamber 34, and accordingly the hydraulic pressure difference ΔP becomes a negative value.

A shifting control portion 102 decides the target shift speed of the automatic transmission 16 to which the present shift speed is changed, based on the actual throttle opening amount θ_{TH} and the vehicle speed V using, for example, the shift diagram (shift map) in FIG. 4 which is stored in advance in a two dimensional coordinate system using the throttle valve opening amount θ_{TH} and the vehicle speed V as parameters. Then, the shifting control portion 102 outputs a switching signal which switches between excitation and non-excitation of the solenoid valves Sol 1 to Sol 5, and the linear solenoid valves SL1 and SL2 for switching between the engagement state and the disengagement state of each of the hydraulic frictional engagement devices (the clutch C and the brake B) of the automatic transmission 16 such that the decided shift speed is achieved.

Also, the shifting portion 102 performs a neutral control which places the automatic transmission 16 in the neutral state and interrupts power transmission path from the engine 12 to the driving wheels by causing the hydraulic frictional engagement devices (the clutch C and the brake B) to be semi-engaged or disengaged in the case where the engine speed N_{E} of the engine 12 is not higher than a predetermined speed, for example, an idle speed N_{EIDL} when the shift lever 72 is operated to the position “D” and the vehicle is stopped. For example, the shifting control portion 102 performs the neutral control which causes the brake B2 to be semi-engaged or disengaged when the clutch C1 and the brake B2 are engaged for achieving the first shift speed as shown in the table in FIG. 2. In the embodiment, the lock-up clutch 26 is placed in the slip state or is engaged when the hydraulic pressure difference ΔP is substantially zero. Therefore, in the case where the lock-up clutch 26 is controlled to be disengaged when the engine speed is low, the hydraulic pressure of the hydraulic oil supplied to the torque converter 14 from the oil pump 88 which operates in synchronization with the engine speed N_{E} would be reduced, and the hydraulic pressure difference ΔP would be reduced, the lock-up clutch 26 would be engaged with increasingly larger engagement force, and the load applied to the engine 12 would increase. Thus, in such a case, the shifting portion 102 performs the neutral control in order to prevent the load applied to the engine 12 from increasing by placing the automatic transmission 16 in the neutral state, and interrupting the power transmission path from the engine 12 to the driving wheels. As a result, for example, the engine speed N_{E} is prevented from becoming unstable when the vehicle is stopped, and the load applied to the engine 12 can be reduced. Accordingly, the idle speed N_{EIDL} of the engine 12 can be decreased, the fuel consumption can be improved.

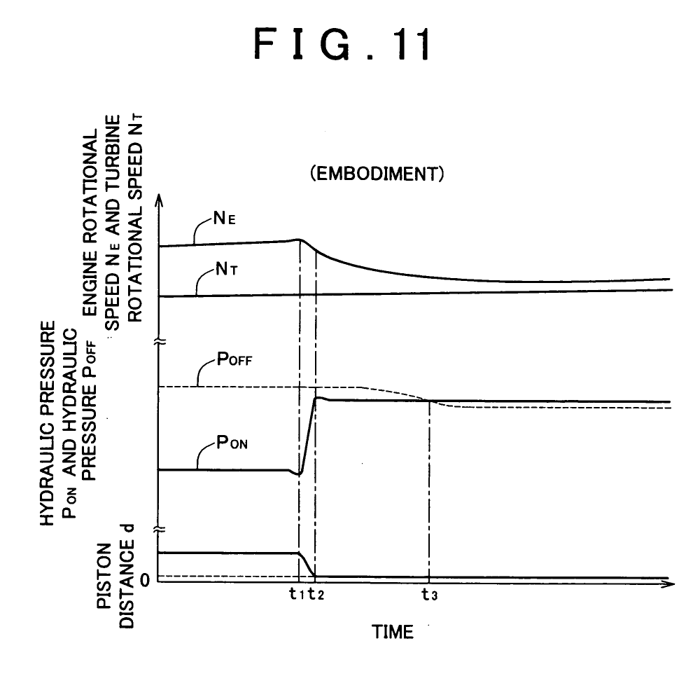

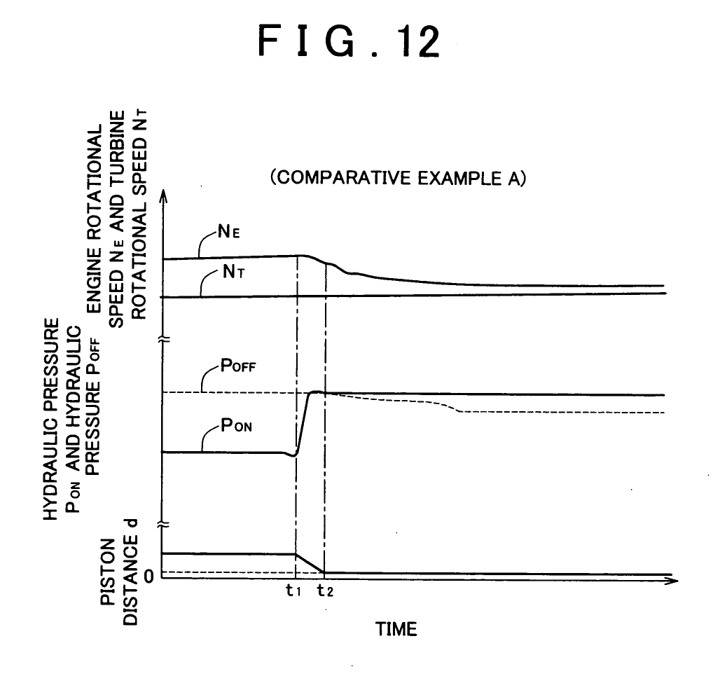

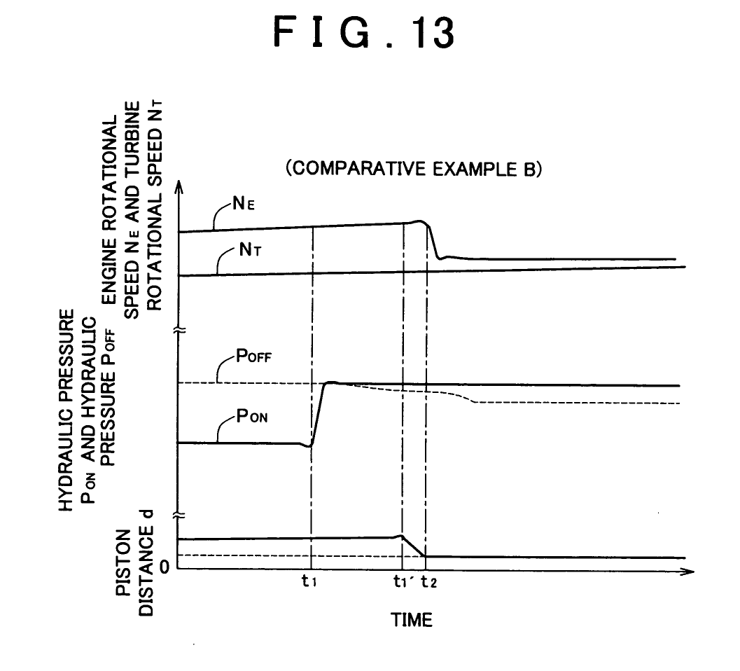

FIG. 11 is a time chart showing a case where the lock-up clutch 26 is controlled so as to be placed in the slip state from the disengagement state according to the embodiment of the invention shown in FIG. 7. Each of FIG. 12 and FIG. 13 is a time chart showing a case according to the conventional example. Particularly, FIG. 13 is a time chart showing a case where movement of a clutch piston 27 toward the front cover 38 is delayed. In each of FIG. 11 to FIG. 13, the slip control is started by the lock-up clutch control portion 100, and the hydraulic pressure P_{ON} is increased at time t₁. In FIG. 11 or FIG. 12, as the hydraulic pressure P_{ON} is increased, the piston distance d is decreased toward a value of substantially zero. However, in FIG. 13, since the hydraulic oil flows into the disengagement side oil chamber 34 from the engagement side oil chamber 32 through the gap between the clutch piston 27 and the front cover 38, and movement of the clutch piston 27 toward the front cover 38 side is delayed, the piston distance d is decreased at time t₁’.

FIG. 1 is greatly different from FIG. 12 and FIG. 13 in that the hydraulic pressure difference ΔP is a negative value during a period from t₂ at which the piston distance d becomes substantially zero to t₃, a period from t, to t₂ is relatively short, and the engine speed N_{E} is promptly decreased to a target slip speed N_{SLP*}. This shows that the slip control can be appropriately started even when the hydraulic pressure P_{ON} is equal to or lower than the hydraulic pressure P_{OFF}, that is, the hydraulic pressure P_{ON} is increased to a relatively small extent.

As described above, according to the embodiment, when the hydraulic pressure difference ΔP is not generated, the lock-up clutch 26 is placed in contact with the front cover 38 of the hydraulic power transmission device such as the torque converter 14 due to the predetermined pressing force Fₚ. The hydraulic pressure difference ΔP is changed so as to be a negative value or a positive value using the lock-up clutch control portion 100, whereby the engagement force of the lock-up clutch 26 is controlled by changing the contact state between the front cover 38 of the torque converter 114 and the lock-up clutch 26. Therefore, the lock-up clutch 26 can be controlled so as to be placed in the slip state not only when the hydraulic pressure difference ΔP is a positive value but also when the hydraulic pressure difference ΔP is a negative value. That is, the lock-up clutch 26 can be appropriately controlled in a range from the complete engagement state in which the engagement force is largest to the slip state in which the engagement force is substantially zero. For example, since the lock-up clutch 26 can be placed in the slip state from the disengagement state even when the hydraulic pressure difference is a negative value, the lock-up clutch 26 can be placed in the slip state by increasing the hydraulic pressure in the engagement side oil chamber 32 to a relatively small extent. Also, the slip control for the lock-up clutch can be appropriately performed even when the load is low. Therefore, it is possible to prevent occurrence of the droning vibration of the vehicle, and to prevent a sudden decrease in the engine speed N_{E} when brake is suddenly applied. Thus, the stable engine speed N_{E} can be maintained. Also, the cost can be reduced as compared with a torque converter having a similar configuration using a component such as a leaf spring or the like. Further, durability of the leaf spring or the like does not need to be considered.

According to the embodiment of the invention, there is provided the shifting control portion 102 which controls shifting by switching between the engagement state and the disengagement state of each of the frictional engagement devices (the clutch C and the brake B) in the automatic transmission 16 to which the output torque T_{E} of the engine 12 is input. In the case where the engine speed N_{E} of the engine 12 is equal to or lower than the predetermined speed when the vehicle is stopped, the shifting control portion 102 places the automatic transmission 16 in the neutral state by causing the frictional engagement devices to be semi-engaged or disengaged. Therefore, by placing the automatic transmission 16 in the neutral state, that is, by interrupting the power transmission path, the load applied to the engine 12 can be prevented from increasing due to an increase in the engagement force of the lock-up clutch 26 in spite of a decrease in the hydraulic pressure supplied to the hydraulic power transmission device such as the torque converter 14 from the oil pump 88 which operates in synchronization with the engine speed N_{E} when the engine speed is low, for example, when the vehicle is stopped. Accordingly, the stable engine speed N_{E} of the engine 12 is maintained. Also, since the load applied to the engine 12 decreases, an idle speed N_{EIDL} of the engine 12 can be decreased, and fuel consumption can be improved.

Although the embodiment of the invention has been described with reference to the drawings, the invention is applied to other embodiments.

For example, in the aforementioned embodiment, the torque converter 14 including the lock-up clutch 26 is used as the hydraulic power transmission device. However, a fluid coupling which does not have the function of amplifying torque may be used as the hydraulic power transmission device.

Also, in the aforementioned embodiment of the invention, the pressure reducing valve 260 reduces the second line pressure P_{L2} by predetermined pressure such that the second line pressure P_{L2} becomes the hydraulic pressure P_{ON}. However, a device which adjusts the second line pressure P_{L2} such that the hydraulic pressure P_{ON} becomes a predetermined pressure may be used. That is, any device may be used as long as the device can control the hydraulic pressure difference ΔP such that the hydraulic pressure difference ΔP becomes a negative value, that is, the hydraulic pressure P_{ON} is equal to or lower than the hydraulic pressure P_{OFF} when the slip control is performed.

Also, in the aforementioned embodiment of the invention, the automatic transmission 16 includes the three planetary gearsets 40, 42, 44, and has six forward speeds. However, any transmission may be used as long as a hydraulic frictional engagement device (clutch C or brake B) is engaged for applying engine brake in the transmission. The number of the planetary gearsets constituting the automatic transmission 16 may be a number other than three. Also, a transmission having five forward speeds, a transmission having four forward speeds, and the like may be employed. Also, the automatic transmission 16 may include a shifting portion including a hydraulic frictional engagement device such as a clutch or a brake, and a one-way clutch, for example, a transmission having a forward speed and a reverse speed or a transmission having two forward speeds; and a continuously variable transmission in which a gear ratio is continuously changed.

The aforementioned embodiment of the invention is exemplary. Various changes and modifications can be made based on knowledge of those skilled in the art.

What is claimed is:

1. A vehicle which includes a hydraulic power transmission device, comprising:
a front cover of the hydraulic power transmission device;
a first oil chamber and a second oil chamber to and from each of which predetermined hydraulic pressure is provided, and each of which is in the hydraulic power transmission device;
a lock-up clutch which is configured to directly connect an input side and an output side of the hydraulic power transmission device when the lock-up clutch and the front cover are placed in contact with each other according to a hydraulic pressure difference between the first oil chamber and the second oil chamber, and
a lock-up clutch control portion which controls engagement force of the lock-up clutch with respect to the front cover by changing pressing force that presses the lock-up clutch to the front cover, the pressing force being changed by changing the hydraulic pressure difference;
wherein the lock-up clutch is in contact with the front cover due to predetermined pressing force when the hydraulic pressure difference is substantially zero.

2. The vehicle according to claim 1, the predetermined pressing force when the hydraulic pressure difference is substantially zero corresponds to a slip state of the lock-up clutch.

3. The vehicle according to claim 1, wherein
the second oil chamber is positioned between the front cover and the lock-up clutch, the first oil chamber is positioned so as to be opposed to the second oil chamber with the lock-up clutch being therebetween, and the hydraulic pressure difference is obtained by subtracting the hydraulic pressure in the second oil chamber from the hydraulic pressure in the first oil chamber; and
the lock-up clutch control portion places the lock-up clutch in contact with the front cover using predetermined pressing force even when the hydraulic pressure difference is a predetermined negative value.

4. The vehicle according to claim 3, the predetermined pressing force when the hydraulic pressure difference is the predetermined negative value corresponds to a slip state of the lock-up clutch.

5. The vehicle according to claim 1, wherein
the second oil chamber is positioned between the front cover and the lock-up clutch, and the first oil chamber is positioned so as to be opposed to the second oil chamber with the lock-up clutch being therebetween; and
the lock-up clutch control portion increases the pressing force by increasing a hydraulic pressing that is provided to the first oil chamber, and decreasing the pressure force by increasing a hydraulic pressure that is supplied to the second oil chamber.

6. The vehicle according to claim 1, further comprising:
shifting control portion which controls shifting by switching between an engagement state and a disengagement state of a frictional engagement device in an automatic transmission to which output torque of an engine is input, the shifting control portion placing the automatic transmission in a neutral state by causing the frictional engagement device to be semi-engaged or to be disengaged when a rotational speed of the engine is equal to or lower than a predetermined rotational speed while the vehicle is stopped.
